(19) United States
(12) Patent Application Publication
(10) Pub. No.: US 2015/0118585 A1
(43) Pub. Date: Apr. 30, 2015

(54) ELECTRONIC DEVICE WITH UNCONTAINED AIR BREATHING BATTERY

(71) Applicant: ZAF Energy Systems, Incorporated, Columbia Falls, MT (US)

(72) Inventors: Howard F. Wilkins, Kalispell, MT (US); Ronald D. Brost, Whitefish, MT (US); Kristine M. Brost, Whitefish, MT (US); Matthew J. Cottrell, Hermosa Beach, CA (US); Randolph M. Kosted, Kalispell, MT (US); Adam Weisenstein, Whitefish, MT (US); William A. Garcia, Columbia Falls, MT (US)

(21) Appl. No.: 14/519,947

(22) Filed: Oct. 21, 2014

Related U.S. Application Data
(60) Provisional application No. 61/895,071, filed on Oct. 24, 2013.

(51) Int. Cl. H01M 2/02; H01M 12/00

(52) U.S. Cl. CPC H01M 2/0202; H01M 12/00; H01M 2220/30
USPC 429/407; 429/403

(57) ABSTRACT

A portable electronics device includes a case, an electrical plane disposed within the case, and a laminated self-supporting uncontained air breathing membrane electrode assembly (MEA). The MEA includes an air positive electrode, a metal negative electrode, and a solid electrolyte in ionic communication with the electrodes. This arrangement, in certain circumstances, does not require a dedicated casing to surround the MEA—reducing a thickness of the device.

### CROSS-REFERENCE TO RELATED APPLICATION

This application claims the benefit of U.S. Provisional Application No. 61/895,071, filed Oct. 24, 2013, the contents of which are hereby incorporated by reference in their entirety.

### TECHNICAL FIELD

This disclosure relates to electronic devices powered by air breathing batteries.

### BACKGROUND

Prismatic (e.g., lithium ion) batteries in modern personal electronics tend to be thick, which increases device dimension and imposes design constraints—reducing ergonomic appeal.

### SUMMARY

A portable electronics device includes a case, an electrical plane disposed within the case, and a laminated self-supporting uncontained air breathing membrane electrode assembly (MEA). The MEA includes an air positive electrode, a metal negative electrode, and a solid electrolyte in ionic communication with the electrodes. The MEA is disposed within the case such that the electrical plane and the air positive electrode define an air exchange chamber in fluid communication with air outside the case and that provides cooling for the electrical plane and an oxidant source for the air positive electrode.

A portable electronics system includes a case, an electrical plane disposed within the case, and a laminated self-supporting uncontained air breathing membrane electrode assembly (MEA). The MEA includes an air positive electrode, a metal negative electrode, and a solid electrolyte in ionic communication with the electrodes. The system also includes a gas diffusion layer disposed between the electrical plan and the MEA, and in fluid communication with air outside the case. The air provides cooling for the electrical plane and an oxidant source for the air positive electrode.

A portable electronics system includes a case, an electrical plane disposed within the case, and a laminated self-supporting uncontained air breathing membrane electrode assembly (MEA). The MEA includes an air positive electrode, a metal negative electrode, and a solid electrolyte in ionic communication with the electrodes. The MEA is disposed within the case such that the case and the air positive electrode define an air exchange chamber in fluid communication with air outside the case and that provides an oxidant source for the air positive electrode.

A portable electronics system includes a case, an electrical plane disposed within the case, and a laminated self-supporting uncontained air breathing membrane electrode assembly (MEA). The MEA includes an air positive electrode, a metal negative electrode, and a solid electrolyte in ionic communication with the electrodes. The system also includes a gas diffusion layer disposed between the case and the MEA, and in fluid communication with air outside the case. The air provides an oxidant source for the air positive electrode.

A portable electronics system includes a case, an electrical plane disposed within the case, and a laminated self-supporting uncontained air breathing membrane electrode assembly (MEA). The MEA includes an air positive electrode, a metal negative electrode, and a solid electrolyte in ionic communication with the electrodes. The MEA is disposed within the case such that the metal negative electrode and the electrical plane define an air exchange chamber that provides cooling for the electrical plane.

### BRIEF DESCRIPTION OF THE DRAWINGS

FIGS. 1 and 2 are schematic diagrams, in cross-section, of battery powered electronic devices.

FIG. 3 is a schematic diagram, in cross-section, of an air breathing battery.

FIGS. 4 through 8 are schematic diagrams, in cross-section, of battery powered electronic devices. Similarly numbered elements may share similar descriptions.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Portable electronic devices often use, for example, lithium cobalt oxide (LiCoO₂) batteries, which offer high energy density and may present safety risks when damaged. Unlike other rechargeable batteries, lithium-ion batteries contain a flammable electrolyte and are kept pressurized. Therefore, the anode, cathode and electrolyte are surrounded by a dedicated battery casing to protect and secure the contents therein.

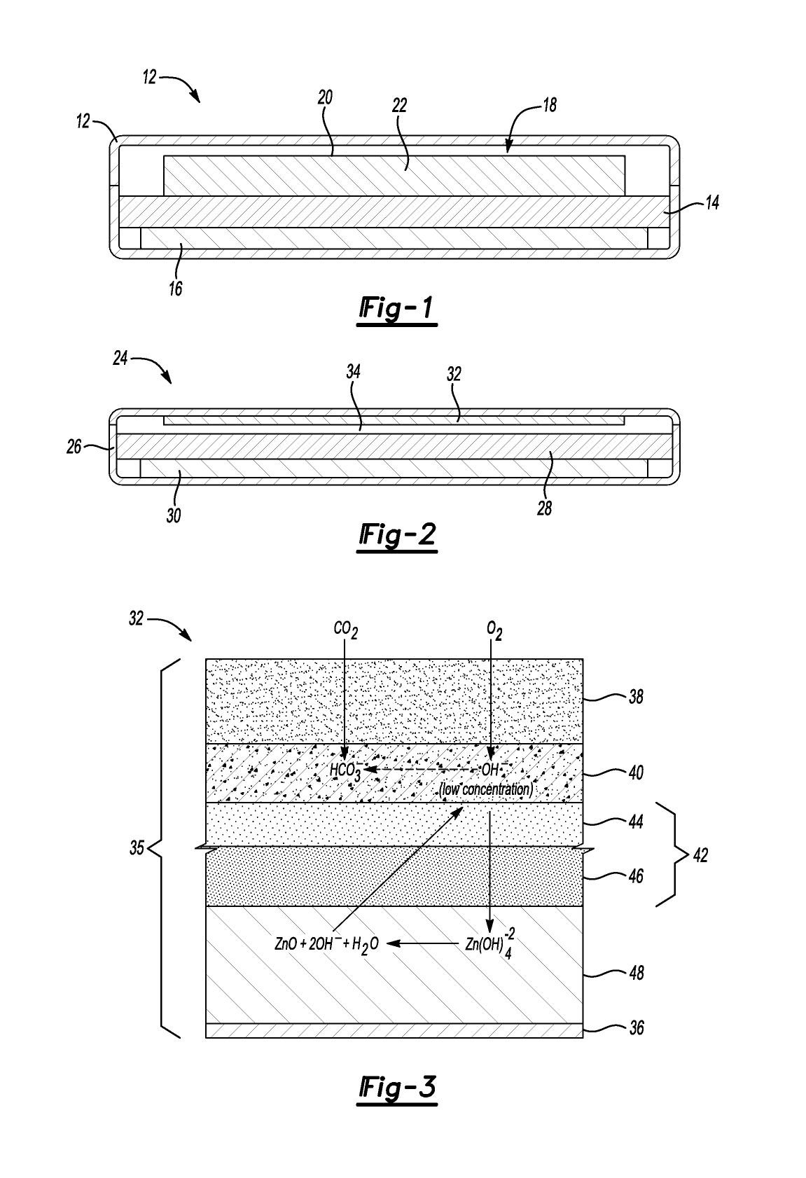

With reference to FIG. 1, a conventional portable electronic device 10 includes a case 12 having an electronics plane 14 (e.g., circuitry, etc.), a display module 16 (e.g., screen), and a lithium-ion battery 18 disposed therein as known in the art. In this example, the display module 16 and battery 18 are mounted on opposite sides of the electronics plane 14. Power from the battery 18 is used by the electronics plane 14 to perform various processing and screen functions.

The battery 18 includes a battery casing 20 surrounding an anode, cathode and electrolyte (collectively 22). The casing 20, by virtue of its existence, adds not an insubstantial amount of overall thickness to the battery 18. (The thickness of the battery 18, for example, is greater than 3 millimeters.) The thickness of the casing 20 therefore contributes to the overall thickness of the electronic device 10.

With reference to FIG. 2, a portable electronic device 24 includes a porous case 26 having an electronics plane 28 (e.g., circuitry, etc.), a display module 30 (e.g., screen), and an air breathing battery 32 disposed therein. In this example, the display module 30 is mounted on one side of the electronics plane 28 and the battery 32 is mounted to the case 26 via a gas permeable adhesive 33 (see, FIG. 4) such that an air gap 34 separates the battery 32 and electronics plane 28. The battery 32 may also be mounted to the case 26 via mechanical fasteners (e.g., screws, etc.) Power from the battery 32 is used by the electronics plane 28 to perform various processing and screen functions. Electrical connections between the battery 32 and the electronics plane 28 run along the perimeter of the case 26. The electronic device 24 may be a cell phone, a tablet, a personal digital assistant, a watch, a lap top computer, a gaming unit, a camera, a hearing aid, a biometric monitor, an unmanned aerial vehicle, a toy, etc.

With reference to FIG. 3, the battery 32 includes a laminated self-supporting uncontained air breathing membrane electrode assembly (MEA) 35 and a current collector 36 in contact therewith. This arrangement, as the name suggests, does not require a casing to surround the MEA 35. Hence, the battery 32 may be thinner than, for example, the battery 18. In other examples, the MEA 35 may include the current collector 36, etc. The MEA 35 includes a gas diffusion layer 38, an air electrode (catalyst and current collector) 40 in contact with the gas diffusion layer 38, a bipolar solid electrolyte 42 in ionic communication with the air electrode 40, and a counter electrode 48 (e.g., an anodic metal) in ionic communication with the solid electrolyte 42. In certain examples, the MEA 35 is rechargeable.

Chemical reactions are illustrated for example purposes. Other chemistries suitable for metal-air batteries, such as aluminum based or magnesium based chemistries, are also contemplated.

The solid electrolyte 42 may include, for example, a neutral or acidic (e.g., pH less than 9) gas impermeable ionomer phase (layer) 44 and an alkaline continuous ionomer phase (layer) 46. The juxtaposition of the layers 44, 46 will induce a stable hydroxide gradient in which the hydroxide ion concentration associated with the neutral (or acidic) phase 44 is lower than that of the alkaline phase 46. The hydroxide ion concentration of the neutral (or acidic) phase 44, for example, may be less than 10⁻⁵ molar, while the hydroxide ion concentration of the alkaline ionomer phase 46, for example, may be greater than 4 molar. A concentration of 10⁻⁵ molar is considered sufficient to prevent dendritic growth therethrough, and so the gradient induced by this arrangement is capable of reducing or eliminating dendritic growth in metal anode batteries while maintaining the alkaline conditions at the anode that are required for efficient operation. Alternatively, a solid alkaline electrolyte may be treated on one side to increase the acidity associated therewith. Other configurations and concentrations may also be used depending on design considerations, expected operating environment, etc.

The acidic polymer 44 may be a material that, on a molecular scale, consists of strongly anionic sites on a structural polymeric backbone (e.g., an ionically conductive dielectric gas impermeable layer such as sulfonated tetrafluoroethylene based fluoropolymer-copolymer or Nafion®), while the alkaline polymer 46 may be a material that consists of strongly cationic sites on a polymeric backbone. When these two materials are in contact with one another, an equilibrium will be established that will distribute an anion (such as hydroxide) preferentially on the alkaline polymer 46, and will have a substantial reduction in hydroxide on the acidic polymer 44. This condition would make it improbable that sufficient hydroxide will be available to react with free carbon dioxide, and will thereby stabilize the battery with respect to carbon dioxide. This is anecdotally realized through known behavior of carbon dioxide with acidic polymers such as Nafion®, which is well known for stability towards carbon dioxide in fuel cells in which an operating life in excess of 5 years is routinely observed with no evidence of carbonate formation, even when the material is continuously exposed to carbon dioxide.

In alternative implementations, the acidic gas impermeable ionomer phase 44 could be replaced with a neutral ionomer, such as polyvinyl alcohol, as mentioned above. This phase could coincidentally act as a binder or as a hygroscopic material that would assist in the retention of water without the risk of flooding the catalyst 40.

The alkaline polymer 46 may be continuous through to the interface of the metal anode 48 such that the anode interface would be in galvanic contact with the catalyst 40. Likewise, the acidic gas-impermeable ionomer phase 44 may be contiguous through the catalyst layer 40 such that the catalyst interface would be in galvanic contact with the metal anode 48.

The catalyst 40 should have access to oxygen, the ionomer 44 (conductive phase to remove hydroxide), water, and the associated current collector. In order for these five components to come together in a triple phase boundary (consisting of gaseous air, liquid water with solvated ions, and a solid conductive catalyst), the catalyst interface may have a certain degree of porosity to allow gas access, yet include a path for electrons to transport in or out of the battery 32 along with a path for water and ions to transport within the battery 32. In order to prevent gases from permeating to the alkaline layer 46, however, a portion of the acidic polymer 44 may be configured as a membrane that allows transport of ions, but does not allow oxygen or carbon dioxide therethrough.

The acidic polymer functional group may include, for example, at least one sulfonic group (previously described), nitroso group, or phosphino group. The polymer backbone may be polystyrene, polysulfone, polyethersulfone, polyetheretherketone, polyphenylene, polybenzimidazole, polyimide, polyarylenether, or a fluorine-containing resin.

The alkaline polymer functional group may include, for example, at least one anion exchange group selected from quartenary ammonium, pyridinium, imidizolium, phosphonium, and sulfonium. The polymer may be polystyrene, polysulfone, polyethersulfone, polyetheretherketone, polyphenylene, polybenzimidazole, polyimide, polyarylenether, or a fluorine-containing resin.

These polymeric materials may be substantially solid such that intermixing between the materials is minimal and that the hydroxide gradient is maintained throughout the operational life of the battery 32.

The hydroxide distribution in such arrangements would result in higher concentrations at the anode and lower concentrations at the cathode, thus simultaneously protecting the cathode from passivation resulting from carbonate formation while facilitating alkaline anodic corrosion of the metal anode and preventing the direct oxidation of the metal.

To form the MEA 35 as a laminated self-supporting structure, the polymeric ion exchange membrane 42, in soluble form using N-methyl-2-pyrrolidone (NMP), dimethyl phthalate (DMF), dimethyl sulfoxide (DMSO), methyl ethyl ketone (MEK), or other suitable solvent, is applied to either or both of the positive and/or negative electrodes by coating, spraying, painting or other dispersive means such that, for example, total solids of 0.05 to 0.10 grams of polymeric ion per square centimeter are deposited on the electrode 48 or 40. In certain embodiments, a gradient is induced through the membrane by using a two-step application in which the more acidic membrane 44 is applied to the air electrode 40, and the more basic membrane material 46 is applied to the metal electrode 48. The coated electrodes are allowed to dry or partially dry in air, a partial vacuum, or heated air, and are then indexed such that the coated face of the air electrode 40 is juxtaposed relative to the coated face of the metal electrode 48. The coated electrodes 40 and 48 are brought together under compression of 0.5 to 5 kilograms per square centimeter. The MEA 35 is then allowed to dry completely under continuing compression and temperature profiles up to 150 degrees Celsius until sufficient adhesion occurs for mechanical lamination to take place. The GDL 38 may be added to the laminated stack by either heat staking, application of adhesive, or adjacent impregnation by ionomer to the outer surface of the air electrode 40, followed by compression and heating as previously described. Because the MEA 35 is laminated, it is flexible and also conformable to a shape of the case 26.

With reference to FIG. 4, the gas diffusion layer 38 is arranged adjacent to the porous case 26 and the metal anode 48 is arranged adjacent to and spaced away from the electronics plane 28 so as to define the air gap 34 that provides cooling for the electrical plane. Air travels between the MEA 35 and outside the electronic device 24 via the porous case 26 and gas permeable adhesive 33.

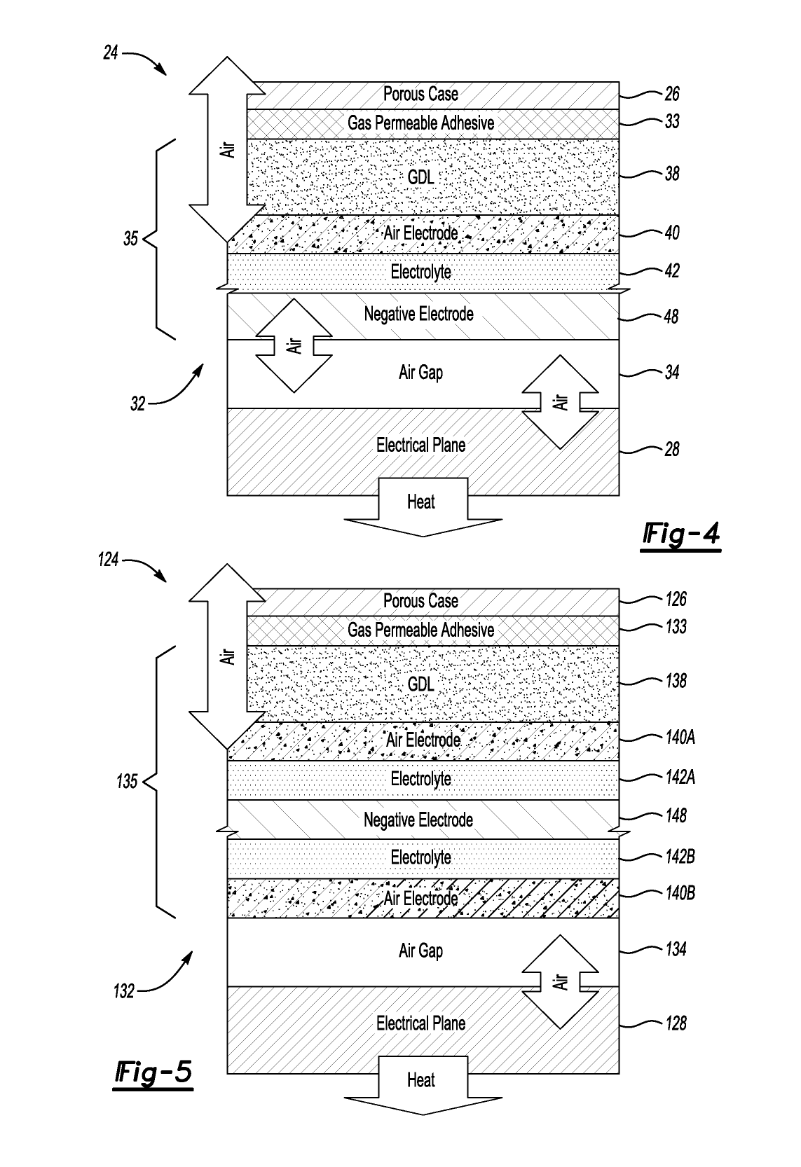

With reference to FIG. 5, a portable electronic device 124 includes a porous case 126 having an electronics plane 128 and an air breathing battery 132 disposed therein. The battery 132 includes an MEA 135 and is mounted to the case 126 via a gas permeable adhesive 133 such that an air gap 134 separates the battery 132 and electronics plane 128. The MEA 135, in this example, includes a gas diffusion layer 138, air electrodes 140a, 140b, solid electrolytes 142a, 142b, and a metal anode 148. The metal anode 148 is sandwiched between the solid electrolytes 142a, 142b, that are sandwiched between the air electrodes 140a, 140b. The air electrode 140a is in contact with the gas diffusion layer 138, which is mounted adjacent to the porous case 126. Air travels between the MEA 135 and outside the electronic device 124 via the porous case 126 and gas permeable adhesive 133. The air cathode 140b is arranged adjacent to and spaced away from the electronics plane 128 so as to define the air gap 134. The air gap 134 provides cooling for the electrical plane 128 and air for the air cathode 140b.

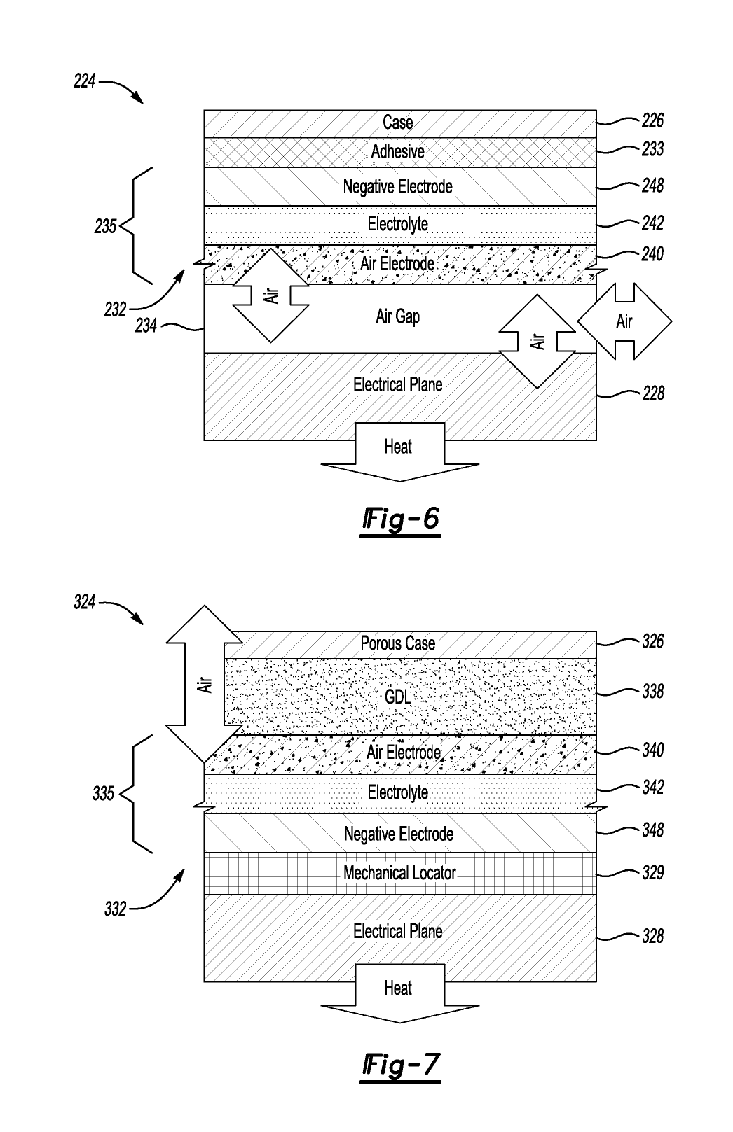

With reference to FIG. 6, a portable electronic device 224 includes a case 226 having an electronics plane 228 and an air breathing battery 232 disposed therein. The battery 232 includes an MEA 235 and is mounted to the case 226 via an adhesive 233 such that an air gap 234 separates the battery 232 and electronics plane 228. The MEA 235, in this example, includes an air cathode 240, solid electrolyte 242, and metal anode 248. The metal anode 248 is arranged adjacent to the case 226 and the air cathode 240 is arranged adjacent to and spaced away from the electronics plane 228 so as to define the air gap 234. The air gap 234 provides cooling for the electrical plane 228 and air for the air cathode 240. Air travels between the MEA 235 and outside the electronic device 224 via passageways (not shown) defined by the case 226 and located in a vicinity of the air gap 234. In other examples, a gas diffusion layer may be positioned between the electrical plane 228 and air cathode 240. The air gap 234 may or may not be present in such examples.

With reference to FIG. 7, a portable electronic device 324 includes a porous case 326 having an electronics plane 328 and an air breathing battery 332 disposed therein. The battery 332 includes an MEA 335 and a gas diffusion layer 338 disposed between the case 326 and MEA 335. The MEA includes an air cathode 340, solid electrolyte 342, and metal anode 348, and is mounted to the electronics plane 328 via a mechanical locator 329 (e.g., screws, bolts, or a snap-lock feature) such that the air cathode 340 is adjacent to the gas diffusion layer 338 and the metal anode 348 is adjacent to the electronics plane 328. Air travels between the gas diffusion layer 338 and outside the electronic device 224 via the porous case 326. In other examples, an air gap may be present between the porous case 326 and MEA 335 or gas diffusion layer 338 depending on whether the gas diffusion layer 338 is included in such examples.

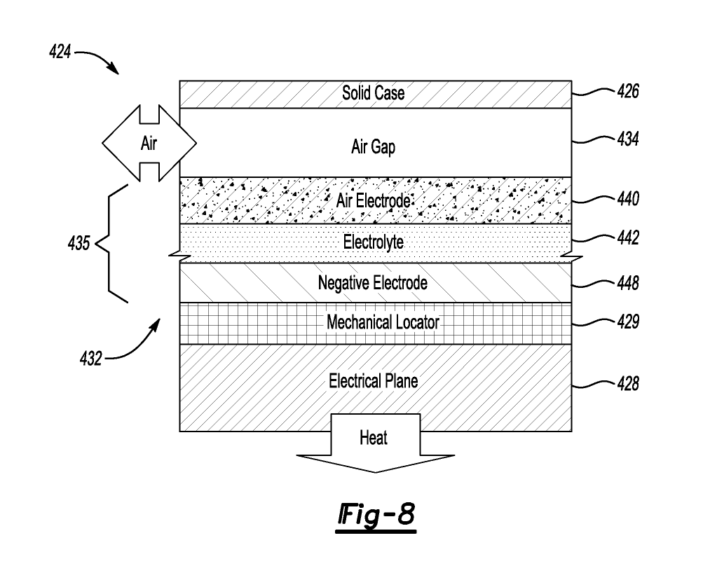

With reference to FIG. 8, a portable electronic device 424 includes a case 426 having an electronics plane 428 and an air breathing battery 432 disposed therein. The battery 432 is mounted to the electronics plane 428 via a mechanical locator 429 such that the case 426 and battery 432 define an air gap 434. Air travels between the battery 432 and outside the electronic device 424 via passageways (not shown) defined by the case 426 in a vicinity of the air gap 434.

The battery 432 includes an MEA 435. The MEA 435 includes an air cathode 440, solid electrolyte 442, and metal anode 448 arranged such that the air cathode 434 is adjacent to the case 426 and the metal anode 448 is adjacent to the electronics plane 428. In other examples, a gas diffusion layer may be positioned between the case 426 and MEA 435. The air gap 434 may or may not be present in such examples.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and could be desirable for particular applications.

What is claimed is:

1. A portable electronics device comprising:
a case;
an electrical plane disposed within the case; and
a laminated self-supporting uncontained air breathing membrane electrode assembly (MEA) including an air positive electrode, a metal negative electrode, and a solid electrolyte in ionic communication with the electrodes, and disposed within the case such that the electrical plane and the air positive electrode define an air exchange chamber in fluid communication with air outside the case and that provides cooling for the electrical plane and an oxidant source for the air positive electrode.

2. The device of claim 1, wherein the MEA is affixed, adhered or mechanically fastened to the case.

3. The device of claim 1, wherein the MEA conforms to a shape of the case.

4. The device of claim 1, wherein the MEA is flexible.

5. The device of claim 1, wherein the MEA is rechargeable.

6. The device of claim 1, wherein the case is air permeable.

7. The device of claim 1, wherein the device is a cell phone, a tablet, a personal digital assistant, a watch, a lap top computer, a gaming unit, a camera, a hearing aid, a biometric monitor, an unmanned aerial vehicle, or a toy.

8. The device of claim 1 further comprising a gas diffusion layer disposed between the case and the MEA.

9. A portable electronics system comprising:
a case;
an electrical plane disposed within the case;
a laminated self-supporting uncontained air breathing membrane electrode assembly (MEA) including an air positive electrode, a metal negative electrode, and a solid electrolyte in ionic communication with the electrodes; and
a gas diffusion layer disposed between the electrical plan and the MEA, and in fluid communication with air outside the case, the air providing cooling for the electrical plane and an oxidant source for the air positive electrode.

10. The system of claim 9, wherein the MEA is affixed, adhered or mechanically fastened to the case.

11. The system of claim 9, wherein the MEA conforms to a shape of the case.

12. The system of claim 9, wherein the MEA is rechargeable.

13. The system of claim 9, wherein the case is air permeable.

14. The system of claim 9, wherein the system is a cell phone, a tablet, a personal digital assistant, a watch, a lap top computer, a gaming device, a camera, or a toy.

15. A portable electronics system comprising:
a case;
an electrical plane disposed within the case; and
a laminated self-supporting uncontained air breathing membrane electrode assembly (MEA) including an air positive electrode, a metal negative electrode, and a solid electrolyte in ionic communication with the electrodes, and disposed within the case such that the case and the air positive electrode define an air exchange chamber in fluid communication with air outside the case and that provides an oxidant source for the air positive electrode.

16. The system of claim 15, wherein the MEA is affixed or mechanically fastened to the electrical plane.

17. The system of claim 15, wherein the MEA is rechargeable.

18. The system of claim 15, wherein the MEA conforms to a shape of the case.

19. The system of claim 15, wherein the MEA is flexible.

20. The system of claim 15, wherein the case is air permeable.

21. The system of claim 15, wherein the system is a cell phone, a tablet, a personal digital assistant, a watch, a lap top computer, a gaming device, a camera, or a toy.

22. A portable electronics system comprising:
a case;
an electrical plane disposed within the case;
a laminated self-supporting uncontained air breathing membrane electrode assembly (MEA) including an air positive electrode, a metal negative electrode, and a solid electrolyte in ionic communication with the electrodes; and
a gas diffusion layer disposed between the case and the MEA, and in fluid communication with air outside the case, the air providing an oxidant source for the air positive electrode.

23. The system of claim 22, wherein the MEA is affixed or mechanically fastened to the electrical plane.

24. The system of claim 22, wherein the MEA is rechargeable.

25. The system of claim 22, wherein the case is air permeable.

26. The system of claim 22, wherein the system is a cell phone, a tablet, a personal digital assistant, a watch, a lap top computer, a gaming device, a camera, or a toy.

27. A portable electronics system comprising:
a case;
an electrical plane disposed within the case; and
a laminated self-supporting uncontained air breathing membrane electrode assembly (MEA) including an air positive electrode, a metal negative electrode, and a solid electrolyte in ionic communication with the electrodes, and disposed within the case such that the metal negative electrode and the electrical plane define an air exchange chamber that provides cooling for the electrical plane.

28. The system of claim 27, wherein the MEA further includes a gas diffusion layer disposed between the case and the air positive electrode.

29. The system of claim 27, wherein the MEA is affixed, adhered or mechanically fastened to the case.

30. The system of claim 27, wherein the MEA conforms to a shape of the case.

31. The system of claim 27, wherein the MEA is rechargeable.

32. The system of claim 27, wherein the case is air permeable.

33. The system of claim 27, wherein the system is a cell phone, a tablet, a personal digital assistant, a watch, a lap top computer, a gaming device, a camera, or a toy.
